(19) United States
(12) Patent Application Publication
(10) Pub. No.: US 2026/0051413 A1
(43) Pub. Date: Feb. 19, 2026

(54) REACTOR AND METHOD FOR INITIATING A NUCLEAR FUSION REACTION WITH PLASMONIC MATERIAL

(71) Applicant: BEIJING GUANGHE CORE TECHNOLOGY CO., LTD., Beijing (CN)

(72) Inventor: Cong WANG, Beijing (CN)

(73) Assignee: BEIJING GUANGHE CORE TECHNOLOGY CO., LTD., Beijing (CN)

(21) Appl. No.: 19/474,375

(22) PCT Filed: Apr. 10, 2023
(86) PCT No.: PCT/CN2023/087324

§ 371 Date: Oct. 24, 2025

(51) Int. Cl. G21B 1/23; G21B 1/19

(52) U.S. Cl. CPC G21B 1/23; G21B 1/19

(57) ABSTRACT

The present invention refers to a type of reactor for initiating and carrying out a nuclear fusion reaction, use of plasmonic material in initiating a nuclear fusion reaction, and a method for initiating a nuclear fusion reaction. By using a plasmonic material to affect resonance effect, preferably plasmonic enhancement effect, a Coulomb explosion can be triggered, and in turn a nuclear fusion reaction can be initiated.

### FIELD OF THE INVENTION

The present invention refers to a type of reactor for initiating a nuclear fusion reaction, use of plasmonic material in initiating a nuclear fusion reaction, and a method for initiating a nuclear fusion reaction.

### BACKGROUND

Plasmonic materials could immensely enhance local energy on surfaces of a nanostructure due to the plasmonic enhancement effect, specifically, the resonant excitations of a metal nanoparticle can confine and/or ‘focus’ the incident light at the ‘tips’ of the nanoparticle, and the resulting intensity at the confined region shows an energy enhancement compared with that of the incident light.

The implementation of controlled nuclear fusion reactions is a major scientific and industrial purpose. However, the current controlled fusion reaction is either performed in a high vacuum, or carried out with lasers of high energy, which are mandatory to implement.

The invention aims to solve this problem. Accordingly, by using a specific reactor and method, in a case that the overall reaction conditions are mild, the controlled fusion reaction could be efficiently initiated.

### SUMMARY OF THE INVENTION

The present invention discloses a type of reactor for initiating and carrying out a nuclear fusion reaction, use of plasmonic material in initiating a nuclear fusion reaction, and a method for initiating a nuclear fusion reaction. By using a plasmonic material to affect resonance effect, preferably plasmonic enhancement effect, a Coulomb explosion can be triggered, and in turn a nuclear fusion reaction can be initiated.

In the present invention, the fusion reaction could be efficiently initiated in a relatively mild condition. More specifically, by using a femtosecond laser pulse with relatively low energy, such as less than 10¹⁴ W/cm², the fusion reaction could be efficiently initiated. This results in high energy efficiency and more ease of operation.

In preferred embodiments of the present invention, stable fusion reaction and high neutron generation efficiency can be achieved. For example, an efficiency of about 10³ fusion neutrons per joule of incident laser energy can be achieved.

One aspect of the present invention is a reactor for initiating and carrying out a nuclear fusion reaction, and the reactor comprises a reaction vessel, and at least one laser source, wherein the reaction vessel comprises plasmonic material located inside the reaction vessel, preferably on a substrate in the reaction vessel or on the inner wall of the reaction vessel, and the reaction vessel holds a fluid comprising thermonuclear material in contact with the plasmonic material;
the at least one laser source can apply femtosecond laser pulses to the fluid, so as to generate bubbles in the fluid with a first pulse, a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.

One preferred aspect of the present invention is a reactor, wherein the plasmonic material is present as a coating on a substrate in the reaction vessel or a coating on the inner wall of the reaction vessel, and the coating is at a position that can be irradiated with the at least one laser source, preferably the thickness of the coating is 1 nm to 1000 nm, or 10 nm to 100 nm, or 20 nm to 50 nm.

Another preferred aspect of the present invention is a reactor, wherein the plasmonic material is present as nano-needles protruded from the inner wall of the reaction vessel, and the nano-needles are located at a position that can be irradiated with the at least one laser source, preferably the nano-needles are arranged to have a mutual focal point, and more preferably the nano-needles have a cross sectional diameter of 1 nm to 1000 nm, or 20 nm to 200 nm.

In a preferred aspect, the first pulse and the second pulse are generated by the same laser source, or by different laser sources, and preferably the time interval between the first pulse and the subsequent pulse is 10 ns to 10000 ns, preferably 100 ns to 1000 ns.

In a preferred aspect, the femtosecond laser pulse has a pulse width of between 20 fs to 10 ps, preferably 20 fs to 50 fs, and an intensity of 10¹² W/cm² or higher, preferably less than 10¹⁴ W/cm².

In a preferred aspect, the femtosecond laser pulse has a frequency of 0.1 MHz to 30 MHz, or 1 MHz to 5 MHz, and a wavelength of 400 nm to 1550 nm, or 550 nm to 1100 nm, or 650 nm to 850 nm.

In a preferred aspect, the thermonuclear material comprises one or more elements with an atomic mass smaller than 56 atomic mass units, preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (14N), and nitrogen-15 ions (e.g., ¹⁵N⁺) or atoms (¹⁵N), or any chemical compounds thereof.

In a preferred aspect, the reaction vessel is a tubular reactor, or a chamber, and the cross sectional surface of the reaction vessel in the vertical direction is round-shaped, semicircle-shaped, arc-shaped, bowl-shaped, rectangular-shaped, or square-shaped.

In a preferred aspect, the reactor further comprises at least one neutron detector used to monitor the neutrons generated in the reaction vessel, and preferably the neutron detector is located outside of the reaction vessel, and/or the reactor further comprises at least one heat exchanger used to transfer the generated heat outside the reaction vessel.

In a preferred aspect, the plasmonic material is selected from the group consisting of C, Na, Al, Si, K, Ti, Fe, Co, Ni, Cu, Zn, Mo, Pd, Ag, In, Sn, W, Pt, Au, Pb, Tl and alloys of two or more such chemical elements and oxide, nitride, carbide of such chemical elements.

In a preferred aspect, the resonance frequency of the plasmonic material is close to the frequency of the femtosecond laser, more preferably, the resonance frequency of the plasmonic material is between 0.5 to 2 times of the frequency of the femtosecond laser, such as between 0.75 to 1.25 times, or 0.8 to 1.2 times of the frequency of the femtosecond laser.

In a preferred aspect, the bubbles have a diameter of 1 nm to 1000 nm, preferably 10 nm to 500 nm, more preferably 50 to 200 nm, and the temperature of the bubbles are 1000 K to 20,000 K, preferably 5000 K to 10,000 K.

In a preferred aspect, the reactor further comprises a component, which can function to periodically occlude or stop the femtosecond laser after said subsequent pulse is applied, preferably for a time period of 10 us or longer, or 100 us or longer, before another first pulse is applied to generate new bubbles.

In a preferred aspect, said component is an occluding component that can occlude the femtosecond laser, such as a shelter, a shutter, or a controlling component that can stop the femtosecond laser.

In a preferred aspect, after applying the subsequent pulse, the occluding or stopping of the femtosecond laser allows the bubbles to cool down to a temperature of 5000 K or lower, preferably 1000 K or lower, before another first pulse is applied to generate new bubbles.

In a preferred aspect, the reactor further comprises a lens located in the light path of the femtosecond laser pulse and downstream of the component, to focus the femtosecond laser before it is irradiated into the fluid.

Another aspect of the present invention is use of a plasmonic material in initiating a nuclear fusion reaction, wherein said use comprises the following steps:
provide a reaction vessel comprising plasmonic material located inside the reaction vessel, preferably on a substrate in the reaction vessel or on the inner wall of the reaction vessel, and such reaction vessel holds a fluid comprising thermonuclear material in contact with the plasmonic material;
irradiate femtosecond laser pulses to the fluid with at least one laser source, firstly generate bubbles in the fluid with a first pulse, and a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.

Another aspect of the present invention is a method of initiating a nuclear fusion reaction, and the method comprises the following steps:
provide a reaction vessel comprising plasmonic material located inside the reaction vessel, and holding a fluid comprising thermonuclear material in contact with the plasmonic material;
irradiate femtosecond laser pulses to the fluid with at least one laser source, firstly generate bubbles in the fluid with a first pulse, and a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.

In a preferred aspect of the use or the method, the plasmonic material is present as a coating on a substrate in the reaction vessel or a coating on the inner wall of the reaction vessel, and the coating is at a position that can be irradiated with the at least one laser source, preferably the thickness of the coating is 1 nm to 1000 nm, or 10 nm to 100 nm, or 20 nm to 50 nm.

In a preferred aspect of the use or the method, the plasmonic material is present as nano-needles protruded from the inner wall of the reaction vessel, and the nano-needles are located at a position that can be irradiated with the at least one laser source, preferably the nano-needles are arranged to have a mutual focal point, and more preferably the nano-needles have a cross sectional diameter of 1 nm to 1000 nm, or 20 nm to 200 nm.

In a preferred aspect of the use or the method, the first pulse and the second pulse are generated by the same laser source, or by different laser sources, and preferably the time interval between the first pulse and the subsequent pulse is 10 ns to 10000 ns, preferably 100 ns to 1000 ns.

In a preferred aspect of the use or the method, the femtosecond laser pulse has a pulse width of between 20 fs to 10 ps, preferably 20 fs to 50 fs, and an intensity of 10¹² W/cm² or higher, preferably less than 10¹⁴ W/cm².

In a preferred aspect of the use or the method, the femtosecond laser pulse has a frequency of 0.1 MHz to 30 MHz, or 1 MHz to 5 MHz, and a wavelength of 400 nm to 1550 nm, or 550 nm to 1100 nm, or 650 nm to 850 nm.

In a preferred aspect of the use or the method, the thermonuclear material comprises one or more elements with an atomic mass smaller than 56 atomic mass units, preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), or any chemical compounds thereof.

In a preferred aspect of the use or the method, the reaction vessel is a tubular reactor, or a chamber, and the cross sectional surface of the reaction vessel in the vertical direction is round-shaped, semicircle-shaped, arc-shaped, bowl-shaped, rectangular-shaped, or square-shaped.

In a preferred aspect of the use or the method, at least one neutron detector is used to monitor the neutrons generated in the reaction vessel, and preferably the neutron detector is located outside of the reaction vessel, and/or at least one heat exchanger is used to transfer the generated heat outside the reaction vessel.

In a preferred aspect of the use or the method, the plasmonic material is selected from the group consisting of C, Na, Al, Si, K, Ti, Fe, Co, Ni, Cu, Zn, Mo, Pd, Ag, In, Sn, W, Pt, Au, Pb, Tl and alloys of two or more such chemical elements and oxide, nitride, carbide of such chemical elements.

In a preferred aspect of the use or the method, the resonance frequency of the plasmonic material is close to the frequency of the femtosecond laser, more preferably, the resonance frequency of the plasmonic material is between 0.5 to 2 times of the frequency of the femtosecond laser, such as between 0.75 to 1.25 times, or between 0.8 to 1.2 times of the frequency of the femtosecond laser.

In a preferred aspect of the use or the method, the bubbles have a diameter of 1 nm to 1000 nm, preferably 10 nm to 500 nm, more preferably 50 to 200 nm, and the temperature of the bubbles are 1000 K to 20,000 K, preferably 5000 K to 10,000 K.

In a preferred aspect of the use or the method, a component is used to periodically occlude or stop the femtosecond laser after said subsequent pulse is applied, preferably for a time period of 10 us or longer, or 100 us or longer, before another first pulse is applied to generate new bubbles.

In a preferred aspect of the use or the method, said component is an occluding component that can occlude the femtosecond laser, such as a shelter, a shutter, or a controlling component that can stop the femtosecond laser.

In a preferred aspect of the use or the method, after applying the subsequent pulse, the occluding or stopping of the femtosecond laser allows the bubbles to cool down to a temperature of 5000 K or lower, preferably 1000 K or lower, before another first pulse is applied to generate new bubbles.

In a preferred aspect of the use or the method, a lens located in the light path of the femtosecond laser pulse and downstream of the component is used to focus the femtosecond laser before it is irradiated into the fluid.

### BRIEF DESCRIPTION OF THE DRAWINGS

FIG. 1 illustrates an embodiment of the present invention wherein the plasmonic material is present as a coating on a substrate.

FIG. 2 illustrates the reaction happened within the bubbles when the subsequent pulse is irradiated on the plasmonic material.

FIG. 3 illustrates a preferred embodiment of the present invention wherein the plasmonic material is present as a coating on a substrate.

FIG. 4 illustrates an embodiment of the present invention wherein the plasmonic material is present as nano-needle.

FIG. 5 illustrates the process of initiating the fusion reaction.

### EMBODIMENTS

The invention demonstrated unexpected that, by using a plasmonic material to affect resonance effect, preferably plasmonic enhancement effect, a Coulomb explosion can be triggered, and in turn a nuclear fusion reaction can be initiated at relatively mild conditions.

Before further description of the present invention, certain terms employed in the specification, examples and appended claims are defined in the following section. The definitions listed herein should be read in light of the remainder of the disclosure and understood as by a person of skill in the art. Unless defined otherwise, all technical and scientific terms used herein have the same meaning as commonly understood by a person of ordinary skill in the art to which this invention belongs.

### Definitions

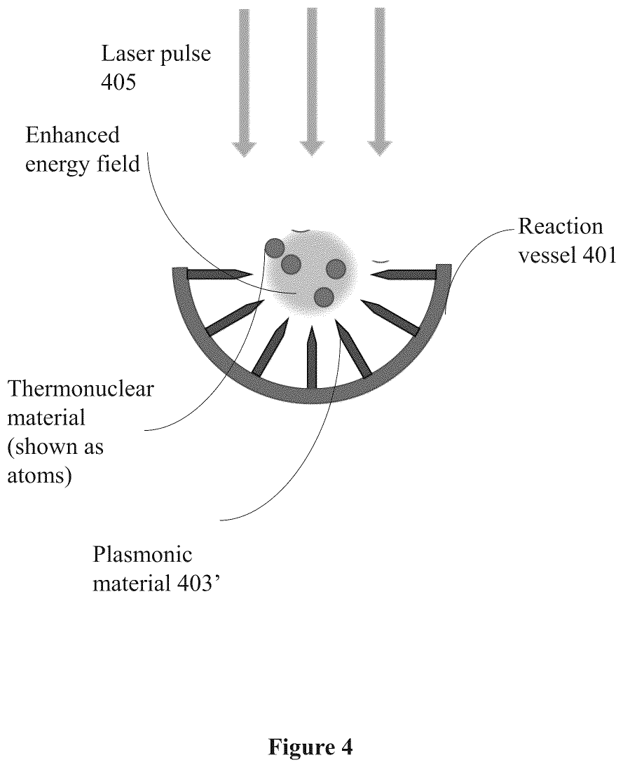

The term “mutual focal point” means that, when the nano-needles are extended with virtual extension lines, such extension lines would intersect in one point. Only for illustrative purposes, the nano-needs have the mutual focal point are shown in FIG. 4.

The term “thermonuclear material” means material that can undergo nuclear reaction when some energy condition is met. The “thermonuclear material” comprises one or more elements with an atomic mass smaller than 56 atomic mass units, preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), or any chemical compounds thereof.

The term “plasmonic material” means material that can affect plasmonic resonance effect, and the plasmonic material is preferably present as a nanostructure. For example, the plasmonic material is selected from the group consisting of C, Na, Al, Si, K, Ti, Fe, Co, Ni, Cu, Zn, Mo, Pd, Ag, In, Sn, W, Pt, Au, Pb, Tl and alloys of two or more such chemical elements and oxide, nitride, carbide of such chemical elements.

The term “plasmonic resonance effect” or “plasmonic enhancement effect” used herein refers to the surface plasmonic effect generated when plasmonic material is excited by electromagnetic irradiation.

The term “nanostructure” used herein refers to a structure having at least one dimension within nanometer range, i.e. about 1 nm to about 1000 nm, preferably about 10 nm to about 1000 nm, about 20 nm to about 800 nm, about 50 nm to about 500 nm, about 70 nm to about 200 nm in at least one of its length, width, height, thickness and cross sectional diameter. Nanostructure can have one dimension which exceeds 1000 nm, for example, having a length in micrometer range such as 1 μm to 5 μm. In certain cases, coatings, needles, tubes and fibers with only two dimensions within nanometer range are also considered as nanostructures. Material of nanostructure may exhibit size-related properties that differ significantly from those observed in bulk materials.

The term “tip” or “tips”, in the context of plasmonic effect, means the area of the plasmonic material wherein the radius of curvature is small enough or the layer is thin enough. For example, if a nanorod corresponding to the resonance wavelength is used, its two ends can be referred to as tips.

The nanostructure of the present invention each independently has a shape of spherical, spike, flake, needle, grass, cylindrical, polyhedral, 3D cone, cuboidal, sheet, coating, hemispherical, irregular 3D shape, porous structure or any combinations thereof.

A plurality of the nanostructures of the present invention can be arranged in a patterned configuration, in a plurality of layers, on a substrate, or randomly dispersed in a medium. For example, nanostructures may be bound to a substrate. In such case, the nanostructures are generally not aggregated together, but rather, pack in an orderly fashion. Alternatively, a plurality of nanostructures can be dispersed in a liquid medium, in which each nanostructure is free to move with respect to any other nanostructures.

For example, the nanostructure could have a spike or grass-like geometric configuration. Optionally, the nanostructure has a geometric configuration with a relatively thin thickness. Preferably, the nanostructure has a configuration of nano-jungle, nano-grass, and/or nano-snowflake.

The nanostructures may be bound to a substrate, for example, the nanostructure may be present as a coating on a substrate. Accordingly, the nanostructures are generally not aggregated together, but rather, pack in an orderly fashion. The substrate could be formed of metal or polymer material (e.g., polyimide, PTFE, polyester, polyethylene, polypropylene, polystyrene, polyacrylonitrile, etc.).

In other embodiments, the nanostructure has a shape of spherical, spike, cylindrical, polyhedral, 3D cone, cuboidal, sheet, coating, hemispherical, irregular 3D shape, porous structure or any combinations thereof.

Furthermore, the nanostructures of the present invention could function in various states, such as dispersed, congregated, or attached/grown on surface of other materials. In preferred embodiments, the nanostructures are present as a coating on a substrate, or as needles in contact with a fluid, and the fluid comprises the thermonuclear material, such as deuterium or its ion, tritium or its ion, or boron or its ion, or compounds or elemental substance thereof, such D₂O or D₂.

### Reactor for Initiating the Nuclear Fusion Reaction

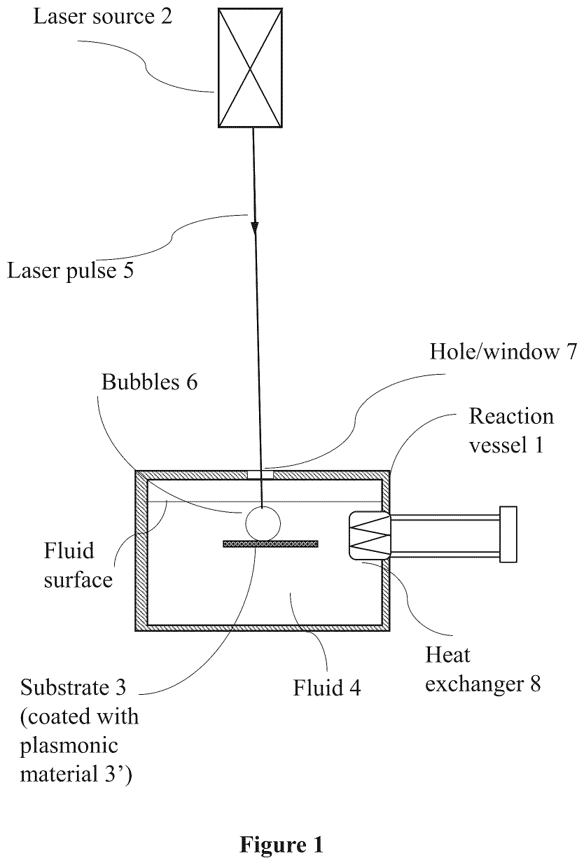

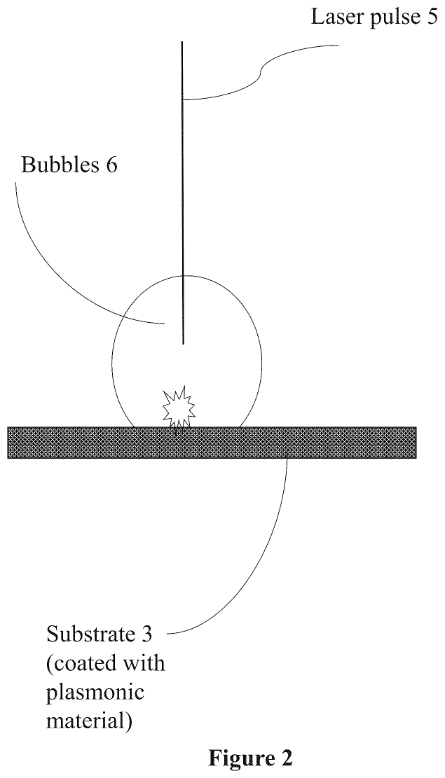

The reactor of the present invention is illustrated in FIG. 1. As shown in FIG. 1, the reactor can comprise a reaction vessel 1, and a laser source 2, wherein the reaction vessel 1 comprises plasmonic material located inside the reaction vessel (specifically, the plasmonic material is present as a coating on a substrate 3, and the plasmonic material 3′ can alternatively be present as a coating or needles on the inner wall of the reaction vessel 1, or as needles on the substrate 3, as long as the coating or needles are at a position that can be irradiated with the laser source 2), and the reaction vessel 1 holds a fluid 4 comprising thermonuclear material in contact with the plasmonic material; the laser source 2 can apply femtosecond laser pulses 5 to the fluid 4, so as to generate bubbles 6 in the fluid 4 with a first pulse, a subsequent pulse is irradiated to the plasmonic material to affect resonance effect, preferably plasmonic enhancement effect, which triggers a Coulomb explosion within the bubbles 6, and can initiate in turn a nuclear fusion reaction on the thermonuclear material (also illustrated in FIG. 2). Said coating has a thickness of about 1 nm to about 1000 nm, or about 10 nm to about 100 nm, or about 20 nm to about 50 nm.

The laser source 2 is for example a table-top femtosecond laser having 5 mJ pulse energy, 40 fs pulse width and 1 MHz repetition rate.

Preferably, the laser pulse 5 is irradiated into the reaction vessel 1 through a hole/window 7. More preferably, the heat generated in the reaction vessel 1 is transferred outside through a heat exchanger 8.

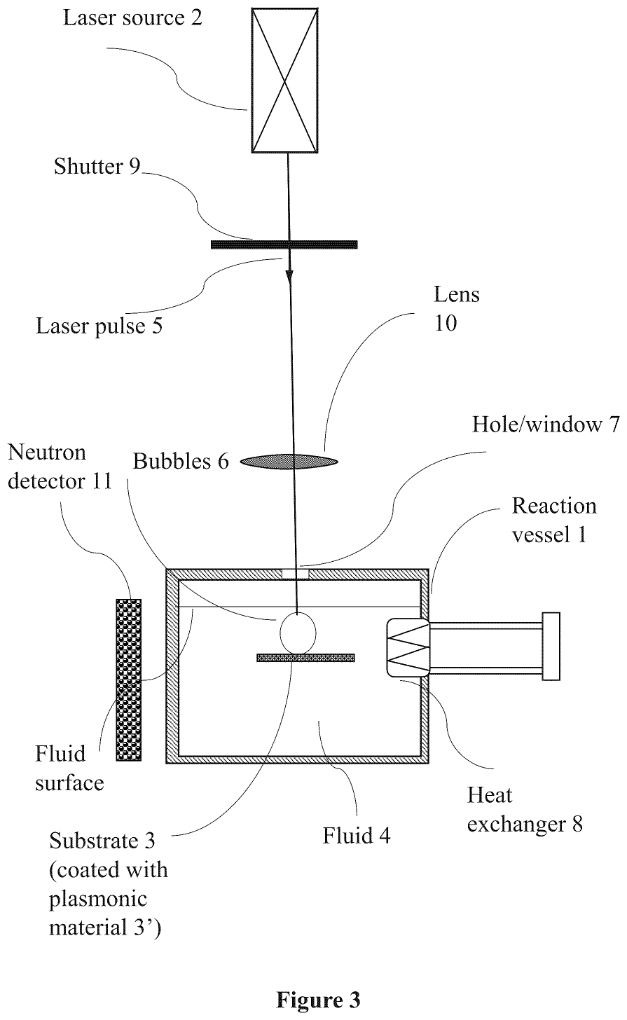

A preferred embodiment of the present invention is illustrated in FIG. 3. Such embodiment comprises a shutter 9, which can periodically occlude the femtosecond laser after said subsequent pulse is applied, preferably for a time period of 10 us or longer, or 100 us or longer, before another first pulse is applied to generate new bubbles. Preferably, the occluding or stopping of the femtosecond laser allows the bubbles to cool down to a temperature of 5000 K or lower, preferably 1000 K or lower, before another first pulse is applied to generate new bubbles.

The embodiment of the present invention can preferably comprise a lens 10 located in the light path of the femtosecond laser pulse 5 and downstream of the shutter 9, to focus the femtosecond laser before it is irradiated into the fluid 4. Preferably, the reactor further comprises at least one neutron detector 11 used to monitor the neutrons generated in the reaction vessel 1, and the neutron detector 11 is located inside of the reaction vessel.

For example, the shutter 9 is used to control the number of pulses irradiated into the reaction chamber 1. Usually, the number of pulses for each open of the shutter is at least two, and is preferably two.

The reaction vessel 1 contains the fluid 4 as the reaction material, in which the nuclear fusion reaction is carried out. The enclosure of the reaction vessel 1 is made of quartz, pyrex glass or metal. The chamber enclosure has at least one hole or one window, which is in a shape that allows to direct the laser pulse 5 into the reaction vessel 1, preferably in a circular shape. The hole/window has a diameter of 0.1 mm to 10 mm, preferably 1 mm to 5 mm. The window is made of quartz or pyrex glass.

The heat exchanger 8 is inside the reaction vessel 1 and in contact with the fluid. The heat exchanger can absorb the heat generated from nuclear fusion reaction, and transfer the heat outside the reaction chamber through a pipe.

The neutron detector 11 is used to detect the number of generated neutrons which is related to the performance of the nuclear fusion.

Another embodiment of the present invention is illustrated in FIG. 4. Such embodiment comprises a reaction vessel 401 and a laser source generating laser pulse 405, wherein the plasmonic material 403′ is present as nano-needles protruded from the inner wall of the reaction vessel 401, and the nano-needles are located at a position that can be irradiated with the laser pulse 405. As illustrated in FIG. 4, the cross sectional surface of the reaction vessel 1 in the vertical direction is semicircle-shaped, arc-shaped, or bowl-shaped, and preferably, the nano-needles are arranged to have a mutual focal point, so as to generate enhanced energy field, and more preferably the nano-needles have a cross sectional diameter of 1 nm to 1000 nm, or 20 nm to 200 nm.

Except for the shapes of the reaction vessel and the plasmonic material, the other features applying for FIGS. 1, 3 and 5 also apply for the embodiment of FIG. 4.

The reactors as shown in the Figures are only for illustrative purposes. The reaction vessel of the present invention can be a tubular reactor, or a chamber, and the cross sectional surface of the reaction vessel in the vertical direction can be round-shaped, semicircle-shaped, arc-shaped, bowl-shaped, rectangular-shaped, or square-shaped. And the laser pulse can be irradiated into the reaction vessel from the top side of the reaction vessel, and can also be irradiated into the reaction vessel from a lateral direction.

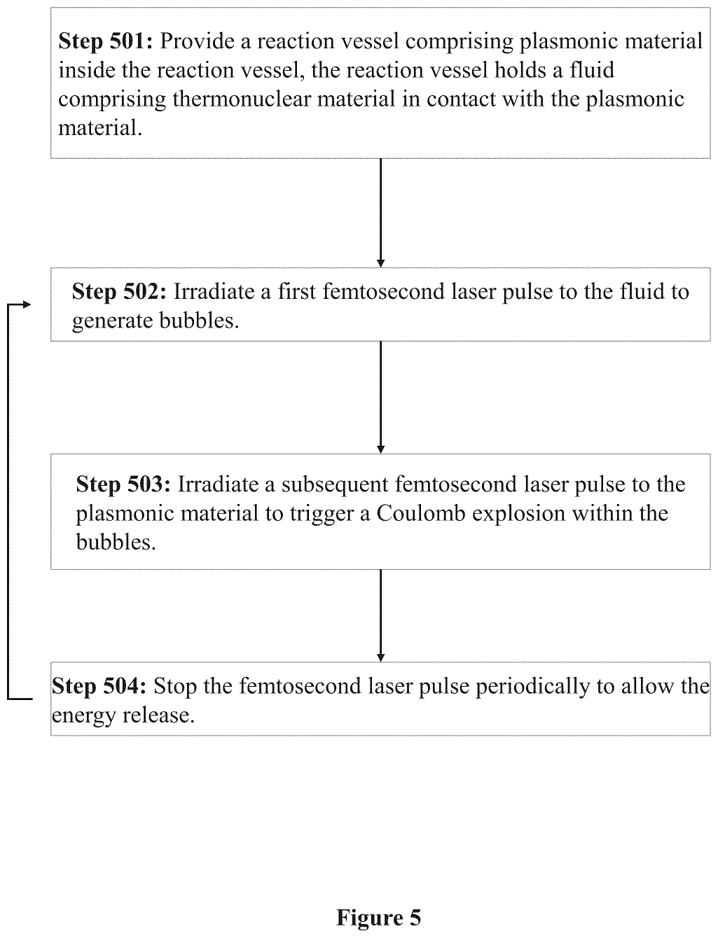

The process for initiating the nuclear fusion reaction is illustrated in FIG. 5, which process comprises the following steps:
Step 501: Provide a reaction vessel comprising plasmonic material inside the reaction vessel, the reaction vessel holds a fluid comprising thermonuclear material in contact with the plasmonic material.

Preferably, the plasmonic material is located on a substrate in the reaction vessel or on the inner wall of the reaction vessel.
Step 502: Irradiate a first femtosecond laser pulse to the fluid to generate bubbles.

The femtosecond laser pulse can be irradiated to the fluid through one or more holes, or one or more windows in the reaction vessel. The number of holes and windows can be set as needs, such as one, two, three, up to ten.

Preferably, the laser pulse is focused by a lens before irradiated to the fluid, to generate bubbles at the focal point of the focused laser pulse. Within the bubbles, gaseous thermonuclear material forms at a high temperature.
Step 503: Irradiate a subsequent femtosecond laser pulse to the plasmonic material to trigger a Coulomb explosion within the bubbles.

The subsequent femtosecond laser pulse irradiated onto the plasmonic material, preferably the plasmonic material inside the bubbles, can affect resonance effect, preferably plasmonic enhancement effect to trigger a Coulomb explosion within the bubbles, and can initiate in turn a nuclear fusion reaction on the thermonuclear material.

Due to the plasmonic enhancement effect, a 102-105 times enhanced energy field is formed around the plasmonic material. Under the synergistic effect of high temperature and high energy field, said Coulomb explosion is triggered.
Step 504: Stop the femtosecond laser pulse periodically to allow the energy release. After said subsequent pulse is applied, preferably for a time period of 10 us or longer, or 100 us or longer, so as to allow the energy release, and allow the bubbles to cool down. Any component that can periodically occlude or stop the femtosecond laser pulse can be used, such as a shutter that can be closed periodically, or a turnplate with slits.

After step 504, go back to step 502 to initiate another period, i.e., irradiate another first pulse to generate new bubbles.

Optionally, during the reaction process, the generated neutrons can be detected or collected with a neutron detector. Also optionally, during the reaction process, a heat exchanger is used to transfer the generated heat outside the reaction vessel.

### Reaction Materials

As reaction material, a fluid can be used. The fluid comprises the thermonuclear material and optionally solvent to dissolve or suspend the thermonuclear material.

The thermonuclear material comprises one or more elements with an atomic mass smaller than 56 atomic mass units. Preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), or any chemical compounds thereof.

The plasmonic material is selected from C, Na, Al, Si, K, Ti, Fe, Co, Ni, Cu, Zn, Mo, Pd, Ag, In, Sn, W, Pt, Au, Pb, Tl and alloys of two or more chemical elements thereof and oxide, nitride, carbide thereof.

### Neutron Reflux

Neutron generation is a reflecting factor of how the fusion reaction proceeds. By using the reactor and/or method of the present invention, stable neutron generation is realized, and with high efficiency.

Preferably, fusion reaction can be initiated with laser pulses with an intensity of 10¹² W/cm² or higher, preferably less than 10¹⁴ W/cm². The laser pulses have a pulse width of between 20 fs to 10 ps, preferably 20 fs to 50 fs.

### EXAMPLES

### Example 1

A 1 cm×1 cm quartz plate was used as a substrate. Several drops of Au nanoparticles suspension were drop-coated onto the quartz plate and air-dried subsequently. Four types of Au nanoparticles with different plasmonic resonance frequency were used in succession. The quartz plate was placed into a 5 mL glass cell containing about 3 mL D₂O under standard temperature and pressure. A Ti: sapphire laser system producing 5 mJ of laser energy in pulses with 40 fs pulse width and a wavelength of 800 nm was used (the intensity of the laser is calculated to be 10¹² W/cm² or higher, and less than 10¹⁴ W/cm²). This laser fires at a repetition rate of 1 MHz and was focused about 1 cm behind the quartz surface by a lens (f=200 mm).

The plasmonic enhanced fusion reaction occurs on nanostructured Au surfaces in the vicinity of the tips of the nanostructured Au. Here light intensity is greatly enhanced due to a surface plasmonic effect; the nano-focused light rapidly heats up deuterium ions around the tips. As a result, these ions explode and eject deuterium ions with energy of keV level.

An efficiency of about 10³ fusion neutrons per joule of incident laser energy is achieved using only 5 mJ laser pulses. However, in previous laser-driven fusion experiments, at least 600 mJ laser pulses are needed to reach similar efficiency. Using the reactor and/or method of the present invention, great progress has been made in driving nuclear fusion of D₂O by a reduced femtosecond laser pulse energy compared to previous studies, specifically, reduced by 10 folds for more, more preferably reduce by 100 folds or more. It is proved in the present invention that, by way of plasmonic enhancement provided by plasmonic material, such as coatings or needles having nanostructures, an underpowered laser pulse can accelerate deuterium ions to a sufficiently high kinetic energy to ignite deuterium nuclear fusion. Without the plasmonic enhancement by nano-Au, no neurons can be detected.

The amount of neurons generated was related to the resonance frequency of nano-Au. The closer the resonance frequency of the plasmonic material is to the frequency of incident laser, the more fusion neurons can be observed, such as those shown in the following table. This clearly indicates that the fusion reaction is resulted from and closely related to the plasmonic enhancements.

| Thermonuclear | Resonance frequency/ | Neutrons detected |
|---|---|---|
| material | wavelength (nm) | per joule |
| D₂O | N/A | 0 |
| D₂O | 520 | >400 |
| D₂O | 600 | >500 |
| D₂O | 700 | 10³ |

N/A means that no plasmonic material is used.

The above only lists a few method and system embodiments of the invention, which are not intended to limit the invention. In practical applications, other specific embodiments can also be transformed according to the description in the method or system embodiments of the invention. Any modifications, equivalent replacements, improvements, etc. made within the spirit and principles of the invention should be included in the scope of protection of the invention.

1. A reactor for initiating and carrying out a nuclear fusion reaction, characterized in that, the reactor comprises a reaction vessel, and at least one laser source, wherein
the reaction vessel comprises plasmonic material located inside the reaction vessel, preferably on a substrate in the reaction vessel or on the inner wall of the reaction vessel, and the reaction vessel holds a fluid comprising thermonuclear material in contact with the plasmonic material;
the at least one laser source can apply femtosecond laser pulses to the fluid, so as to generate bubbles in the fluid with a first pulse, a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.

2. The reactor according to claim 1, characterized in that, the plasmonic material is present as a coating on a substrate in the reaction vessel or a coating on the inner wall of the reaction vessel, and the coating is at a position that can be irradiated with the at least one laser source, preferably the thickness of the coating is 1 nm to 1000 nm, or 10 nm to 100 nm, or 20 nm to 50 nm.

3. The reactor according to claim 1, characterized in that, the plasmonic material is present as nano-needles protruded from the inner wall of the reaction vessel, and the nano-needles are located at a position that can be irradiated with the at least one laser source, preferably the nano-needles are arranged to have a mutual focal point, and more preferably the nano-needles have a cross sectional diameter of 1 nm to 1000 nm, or 20 nm to 200 nm.

4. The reactor according to claim 1, characterized in that, the first pulse and the second pulse are generated by the same laser source, or by different laser sources, and preferably the time interval between the first pulse and the subsequent pulse is 10 ns to 10000 ns, preferably 100 ns to 1000 ns.

5. The reactor according to claim 1, characterized in that, the femtosecond laser pulse has a pulse width of between 20 fs to 10 ps, preferably 20 fs to 50 fs, and an intensity of 10¹² W/cm² or higher, preferably less than 10¹⁴ W/cm².

6. The reactor according to claim 1, characterized in that, the femtosecond laser pulse has a frequency of 0.1 MHz to 30 MHz, or 1 MHz to 5 MHz, and a wavelength of 400 nm to 1550 nm, or 550 nm to 1100 nm, or 650 nm to 850 nm.

7. The reactor according to claim 1, characterized in that, the thermonuclear material comprises one or more elements with an atomic mass smaller than 56 atomic mass units, preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), or any chemical compounds thereof.

8. The reactor according to claim 1, characterized in that, the reaction vessel is a tubular reactor, or a chamber, and the cross sectional surface of the reaction vessel in the vertical direction is round-shaped, semicircle-shaped, arc-shaped, bowl-shaped, rectangular-shaped, or square-shaped.

9. The reactor according to claim 1, characterized in that, the reactor further comprises at least one neutron detector used to monitor the neutrons generated in the reaction vessel, and preferably the neutron detector is located outside of the reaction vessel, and/or the reactor further comprises at least one heat exchanger used to transfer the generated heat outside the reaction vessel.

10. The reactor according to claim 1, characterized in that, the plasmonic material is selected from the group consisting of C, Na, Al, Si, K, Ti, Fe, Co, Ni, Cu, Zn, Mo, Pd, Ag, In, Sn, W, Pt, Au, Pb, Tl and alloys of two or more such chemical elements and oxide, nitride, carbide of such chemical elements, preferably, the resonance frequency of the plasmonic material is close to the frequency of the femtosecond laser, more preferably, the resonance frequency of the plasmonic material is between 0.5 to 2 times of the frequency of the femtosecond laser, such as between 0.75 to 1.25 times, or between 0.8 to 1.2 times of the frequency of the femtosecond laser.

11. The reactor according to claim 1, characterized in that, the bubbles have a diameter of 1 nm to 1000 nm, preferably 10 nm to 500 nm, more preferably 50 to 200 nm, and the temperature of the bubbles are 1000 K to 20,000 K, preferably 5000 K to 10,000 K.

12. The reactor according to claim 1, characterized in that, the reactor further comprises a component, which can function to periodically occlude or stop the femtosecond laser after said subsequent pulse is applied, preferably for a time period of 10 μs or longer, or 100 μs or longer, before another first pulse is applied to generate new bubbles.

13. The reactor according to claim 12, wherein the component is an occluding component that can occlude the femtosecond laser, such as a shelter, a shutter, or a controlling component that can stop the femtosecond laser.

14. The reactor according to claim 12, after applying the subsequent pulse, the occluding or stopping of the femtosecond laser allows the bubbles to cool down to a temperature of 5000 K or lower, preferably 1000 K or lower, before another first pulse is applied to generate new bubbles.

15. The reactor according to claim 12, wherein the reactor further comprises a lens located in the light path of the femtosecond laser pulse and downstream of the component, to focus the femtosecond laser before it is irradiated into the fluid.

16. Use of a plasmonic material in initiating a nuclear fusion reaction, characterized in that, provide a reaction vessel comprising plasmonic material located inside the reaction vessel, preferably on a substrate in the reaction vessel or on the inner wall of the reaction vessel, and such reaction vessel holds a fluid comprising thermonuclear material in contact with the plasmonic material; irradiate femtosecond laser pulses to the fluid with at least one laser source, firstly generate bubbles in the fluid with a first pulse, and a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.

17. The use according to claim 16, characterized in that, the plasmonic material is present as a coating on a substrate in the reaction vessel or a coating on the inner wall of the reaction vessel, and the coating is at a position that can be irradiated with the at least one laser source, preferably the thickness of the coating is 1 nm to 1000 nm, or 10 nm to 100 nm, or 20 nm to 50 nm.

18. The use according to claim 16, characterized in that, the plasmonic material is present as nano-needles protruded from the inner wall of the reaction vessel, and the nano-needles are located at a position that can be irradiated with the at least one laser source, preferably the nano-needles are arranged to have a mutual focal point, and more preferably the nano-needles have a cross sectional diameter of 1 nm to 1000 nm, or 20 nm to 200 nm.

19. The use according to claim 16, characterized in that, the first pulse and the second pulse are generated by the same laser source, or by different laser sources, and preferably the time interval between the first pulse and the subsequent pulse is 10 ns to 10000 ns, preferably 100 ns to 1000 ns.

20. The use according to claim 16, characterized in that, the femtosecond laser pulse has a pulse width of between 20 fs to 10 ps, preferably 20 fs to 50 fs, and an intensity of 10¹² W/cm² or higher, preferably less than 10¹⁴ W/cm².

21. The use according to claim 16, characterized in that, the femtosecond laser pulse has a frequency of 0.1 MHz to 30 MHz, or 1 MHz to 5 MHz, and a wavelength of 400 nm to 1550 nm, or 550 nm to 1100 nm, or 650 nm to 850 nm.

22. The use according to claim 16, characterized in that, the thermonuclear material comprises one or more elements with an atomic mass smaller than 56 atomic mass units, preferably, the thermonuclear material comprises one or more elements selected from the group consisting of protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (⁷Li), boron-10 ions (e.g., ¹⁰B⁺) or atoms (¹⁰B), boron-11 ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), or any chemical compounds thereof.

23. The use according to claim 16, characterized in that, the reaction vessel is a tubular reactor, or a chamber, and the cross sectional surface of the reaction vessel in the vertical direction is round-shaped, semicircle-shaped, arc-shaped, bowl-shaped, rectangular-shaped, or square-shaped.

24. The use according to claim 16, characterized in that,
at least one neutron detector is used to monitor the neutrons generated in the reaction vessel, and preferably the neutron detector is located outside of the reaction vessel, and/or
at least one heat exchanger is used to transfer the generated heat outside the reaction vessel.

25. The use according to claim 16, characterized in that, the plasmonic material is selected from the group consisting of C, Na, Al, Si, K, Ti, Fe, Co, Ni, Cu, Zn, Mo, Pd, Ag, In, Sn, W, Pt, Au, Pb, Tl and alloys of two or more such chemical elements and oxide, nitride, carbide of such chemical elements, preferably, the resonance frequency of the plasmonic material is close to the frequency of the femtosecond laser, more preferably, the resonance frequency of the plasmonic material is between 0.5 to 2 times of the frequency of the femtosecond laser, such as between 0.75 to 1.25 times, or between 0.8 to 1.2 times of the frequency of the femtosecond laser.

26. The use according to claim 16, characterized in that, the bubbles have a diameter of 1 nm to 1000 nm, preferably 10 nm to 500 nm, more preferably 50 to 200 nm, and the temperature of the bubbles are 1000 K to 20,000 K, preferably 5000 K to 10,000 K.

27. The use according to claim 16, characterized in that, a component is used to periodically occlude or stop the femtosecond laser after said subsequent pulse is applied, preferably for a time period of 10 μs or longer, or 100 μs or longer, before another first pulse is applied to generate new bubbles.

28. The use according to claim 27, wherein the component is an occluding component that can occlude the femtosecond laser, such as a shelter, a shutter, or a controlling component that can stop the femtosecond laser.

29. The use according to claim 27, after applying the subsequent pulse, the occluding or stopping of the femtosecond laser allows the bubbles to cool down to a temperature of 5000 K or lower, preferably 1000 K or lower, before another first pulse is applied to generate new bubbles.

30. The use according to claim 27, wherein a lens located in the light path of the femtosecond laser pulse and downstream of the component is used to focus the femtosecond laser before it is irradiated into the fluid.

31. A method of initiating a nuclear fusion reaction, characterized in that,
provide a reaction vessel comprising plasmonic material located inside the reaction vessel, and holding a fluid comprising thermonuclear material in contact with the plasmonic material;
irradiate femtosecond laser pulses to the fluid with at least one laser source, firstly generate bubbles in the fluid with a first pulse, and a subsequent pulse is irradiated to the plasmonic material to affect resonance effect, preferably plasmonic enhancement effect, which triggers a Coulomb explosion within the bubbles, and can initiate in turn a nuclear fusion reaction on the thermonuclear material.
